(19) United States
(12) Patent Application Publication
(10) Pub. No.: US 2026/0186287 A1
(43) Pub. Date: Jul. 2, 2026

(54) MICROSCOPE OBJECTIVE TURRET AND MICROSCOPE

(71) Applicant: AAC Microtech (Changzhou) Co., Ltd., Changzhou City (CN)

(72) Inventors: Chongdeng Wu, Changzhou (CN); Qihuan Zhu, Changzhou (CN); Rui Zhang, Changzhou (CN); Huifang Dong, Changzhou (CN); Xueyuan Zhu, Changzhou (CN)

(21) Appl. No.: 19/322,661

(22) Filed: Sep. 8, 2025

Related U.S. Application Data
(63) Continuation of application No. PCT/CN2024/143943, filed on Dec. 30, 2024.

(51) Int. Cl. G02B 21/24

(52) U.S. Cl. CPC G02B 21/248

(57) ABSTRACT

The present application provides a microscope objective turret and a microscope. The microscope objective turret includes a base provided with an aperture, a turret rotatably connected to the base and forming an accommodating space with the base, which is provided with a plurality of objective mounting holes to align with the light-transmitting aperture, a rotating connection member fixedly connected to the turntable and accommodated within the accommodating space, a motor coaxially arranged with the rotating connection member, a reducer coaxially and fixedly connected to the motor, and a first rotary encoder coaxially arranged with the rotating connection member. The motor drives the reducer to rotate, and the reducer drives the rotating connection member to rotate, thereby driving the first rotary encoder and the turntable to rotate. The present application achieves full closed-loop feedback of the position and higher positioning accuracy.

### CROSS-REFERENCE TO RELATED APPLICATIONS

This application is a continuation of International Application No. PCT/CN2024/143943, filed Dec. 30, 2024, the entire contents of which are incorporated herein by reference.

### TECHNICAL FIELD

The present application relates to the field of microscope technologies, in particular to a microscope objective turret and a microscope.

### BACKGROUND

A microscope is an optical instrument configured to observe microscopic objects. Through the optical design of the objective lens, it can converge the light from the observed sample to form a clear image. Whether observing the same sample or different samples, there may be varying requirements for magnification. Therefore, microscope objective turrets are implemented in the relevant art. During observation, the turret can be rotated to select and replace objective lenses with different magnifications. However, in conventional objective lens turrets, the positioning unit employs a mechanical positioning method where a spring plate is embedded in a groove, which cannot achieve precise positioning.

Therefore, it is necessary to provide a new microscope objective turret.

### SUMMARY

An object of the present application is to provide a microscope objective turret that addresses the technical issue of the inability to achieve precise positioning in the related art.

The technical solution of the present application is as follows:

In the first aspect, provided is a microscope objective turret, including:
a base having a light-transmitting aperture;
a turntable rotatably connected to the base and forming an accommodating space with the base, wherein the turntable is provided with a plurality of objective mounting holes, and the light-transmitting aperture is aligned with any one of the objective mounting holes;
a rotating connection member fixedly connected to the turntable and accommodated within the accommodating space;
a motor coaxially arranged with the rotating connection member;
a reducer coaxially and fixedly connected to the motor; and
a first rotary encoder coaxially arranged with the rotating connection member;
wherein the motor is configured to drive the reducer to rotate, and the reducer drives the rotating connection member to rotate, thereby driving the first rotary encoder and the turntable to rotate; the first rotary encoder is configured to measure rotational angle data of the motor and feed it back to an external controller.

Furthermore, in some embodiments, the rotating connection member includes a connection portion fixedly assembled to the turntable, and a connection shaft fixedly connected to the connection portion, wherein an end of the connection shaft away from the connection portion is connected to the first rotary encoder.

Furthermore, in some embodiments, the first rotary encoder is provided with a first rotary portion coaxially arranged with the connection shaft and a first measurement portion arranged on an outer peripheral side of the first rotary portion; the first measurement portion is configured to measure rotational angle data of the first rotary portion and feed it back to the external controller.

Furthermore, in some embodiments, the microscope objective turret further includes a coupling, which is disposed between the motor and the reducer, wherein the reducer and the motor rotate coaxially via the coupling, the connection shaft is sequentially arranged through the reducer, the coupling, and the motor from the connection portion to connect with the first rotary encoder.

Furthermore, in some embodiments, the microscope objective turret further includes a motor mount for accommodating the motor and fixedly accommodated within the accommodation space, wherein opposite end of the motor mount along the connection shaft are provided with a first clearance hole and a second clearance hole, respectively; the coupling is at least partially located within the first clearance hole to connect to the motor, and an end of the connection shaft close to the first rotary encoder extends through the second clearance holes to be assembled and connected to the first rotary encoder.

Furthermore, in some embodiments, the motor mount includes a base plate fixedly connected to the base and a side wall connected to a side of the base and surrounding an outer peripheral side of the motor; the base is provided with a groove, and a side of the base plate away from the side wall covers the groove to form an assembly space for accommodating the first rotary encoder.

Furthermore, in some embodiments, the microscope objective turret further includes a second rotary encoder disposed between the motor support and the coupling, wherein the second rotary encoder is configured to measure the rotational angle data of the motor and feed it back to the external controller.

Furthermore, in some embodiments, the second rotary encoder includes a second rotary portion fixedly sleeved around an outer side of the coupling, and a second measurement portion arranged around an outer peripheral side of the second rotary portion and fixedly connected to the motor mount, wherein the second measurement portion is configured to measure rotational angle data of the second rotary portion and feed it back to the external controller.

Furthermore, in some embodiments, an outer peripheral side of the base is provided with a first limiting groove with an opening facing the turntable, and an outer peripheral side of the turntable is provided with a second limiting groove with an opening facing the base; the first limiting groove and the second limiting groove are arranged oppositely and spaced apart to form a limiting space, and the microscope objective turret further includes a support member disposed within the limiting space.

The second aspect of the present application provides a microscope including a plurality of objectives and the aforementioned microscope objective turret, wherein the plurality of objectives are removably connected to the plurality of objective mounting holes.

The beneficial effects of the present application are as follows: in the present application, the turntable can rotate relative to the base, enabling the light-transmitting aperture on the base to align with any one of the objective mounting holes on the turntable. Thus, when an objective lens is mounted in the objective mounting hole, a light path can be formed between the light-transmitting aperture and the objective lens to achieve the magnification function of the objective lens. Additionally, multiple objective mounting holes can accommodate different objective lenses, thereby meeting the requirements for different magnification effects. Furthermore, the motor, the reducer, the rotating connection member, and the first rotary encoder are coaxially arranged, and the rotating connection member is fixedly connected to the turntable. Thus, when the motor drives the reducer to rotate, the reducer drives the rotating connection member to rotate, simultaneously driving the first rotary encoder and the turntable to rotate synchronously. The first rotary encoder can feed the rotational angle data of the motor back to an external controller. The controller can determine whether the target position has been reached based on the difference between the actual data and the set data. If the target position has not been reached, the motor continues to drive the rotation until the objective mounting hole on the turntable reaches the set target position, thereby achieving positioning of the objective mounting hole and ultimately aligning the objective lens with the light-transmitting hole. Therefore, the present application can determine whether the turntable has rotated to the correct position based on the first rotary encoder. Compared to the mechanical positioning method in the related art, the present application can achieve full closed-loop feedback of the position and has higher positioning accuracy. In addition, by adding a reducer in the present application, a smaller power motor can be used to obtain greater torque, thereby increasing the load-bearing capacity.

### BRIEF DESCRIPTION OF THE DRAWINGS

FIG. 1 is a three-dimensional structural schematic diagram of a microscope objective turret according to the first embodiment of the present application.

FIG. 2 is a sectional schematic diagram of the microscope objective turret taken along line A-A in FIG. 1 according to the first embodiment of the present application.

FIG. 3 is a three-dimensional exploded view of the microscope objective turret according to the first embodiment of the present application.

FIG. 4 is a three-dimensional structural schematic diagram of the microscope objective turret according to the second embodiment of the present application.

FIG. 5 is a cross-sectional schematic diagram of the microscope objective turret taken along the line A-A in FIG. 4 according to the second embodiment of the present application.

FIG. 6 is a three-dimensional exploded view of the microscope objective turret according to the second embodiment of the present application.

In the figures: 1, base; 11, light-transmitting hole; 12, groove; 13, first limiting groove; 14, protrusion; 141, mounting hole; 2, turntable; 21, objective lens assembly hole; 22, second limiting groove; 3, rotating connection member; 31, connection portion; 32, connection shaft; 4, motor; 5, reducer; 6, first rotary encoder; 61, first rotary portion; 62, first measurement portion; 7, coupling; 8, motor mount; 801, first clearance hole; 802, second clearance hole; 81, base; 82, side wall; 9, second rotary encoder; 91, second rotating portion; 92, second measurement portion; 10, support member; and 100, accommodating space.

### DETAILED DESCRIPTION OF THE EMBODIMENTS

The present application will be described in further detail with reference to the accompanying drawings and embodiments.

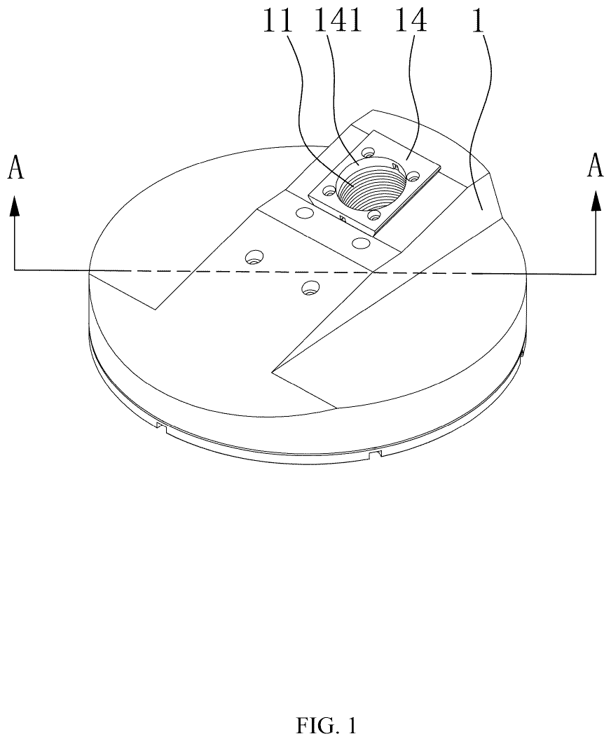

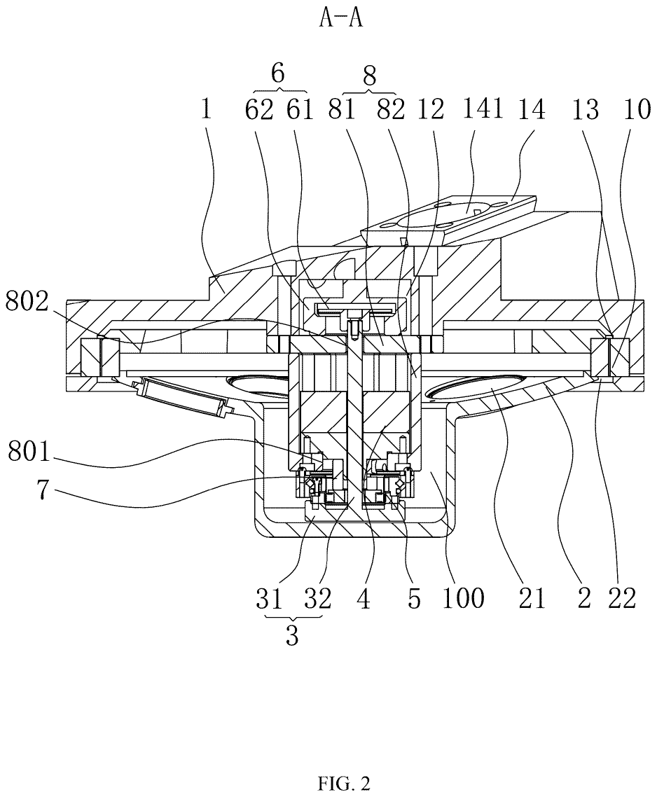

As shown in FIGS. 1 to 3, the first embodiment of the present application provides a microscope objective turret, including a base 1, a turntable 2 rotatably connected to the base 1 and forming an accommodating space 100 with the base 1. The base 1 is provided with a light-transmitting aperture 11, the turntable 2 is provided with a plurality of objective mounting holes 21, and the light-transmitting aperture 11 is aligned with any one of the objective mounting holes 21. The microscope objective turret further includes a rotating connection member 3 fixedly connected to the turntable 2 and accommodated within the accommodating space 100, a motor 4 coaxially arranged with the rotating connection member 3, a reducer 5 coaxially and fixedly connected to the motor 4, and a first rotary encoder 6 coaxially arranged with the rotating connection member 3. The motor 4 is configured to drive the reducer 5 to rotate, and the reducer 5 drives the rotating connection member 3 to rotate, thereby driving the first rotary encoder 6 and the turntable 2 to rotate. The first rotary encoder 6 is configured to measure the rotation angle data of the motor 4 and feed it back to an external controller.

In this embodiment of the invention, the turntable 2 can rotate relative to the base 1, enabling the light-transmitting hole 11 on the base 1 to align with any objective mounting hole 21 on the turntable 2. Thus, when an objective lens is mounted in the objective mounting hole 21, a light path can be formed between the light-transmitting hole 11 and the objective lens to achieve the magnification function of the objective lens. Additionally, multiple objective mounting holes 21 can accommodate different objective lenses, thereby meeting the requirements for different magnification effects. Furthermore, the motor 4, the reducer 5, the rotating connection member 3, and the first rotary encoder 6 are coaxially arranged, and the rotating connection member 3 is fixedly connected to the turntable 2. Thus, when the motor 4 drives the reducer 5 to rotate, the reducer 5 drives the rotating connection member 3 to rotate, simultaneously driving the first rotary encoder 6 and the turntable 2 to rotate synchronously. The first rotary encoder 6 can feed back the rotational angle data of motor 4 to an external controller. The controller can determine whether the target position has been reached based on the difference between the actual data and the set data. If the target position has not been reached, the motor 4 continues to drive the rotation until the objective mounting hole 21 on turntable 2 reaches the set target position, thereby achieving the positioning of the objective mounting hole 21 and ultimately aligning the objective lens with the light-transmitting hole 11. Therefore, the first embodiment of the present application can determine whether the turntable 2 has rotated into position based on the first rotary encoder 6. Compared with the mechanical positioning method in the related art, the first embodiment of the present application can achieve full closed-loop feedback of the position and has higher positioning accuracy. In addition, by adding the reducer 5 in the first embodiment of the present application, the motor 4 with a smaller power can achieve greater torque, thereby increasing the load-bearing capacity.

Furthermore, the rotating connection member 3 includes a connection portion 31 fixedly assembled to the turntable 2, and a connection shaft 32 fixedly connected to the connection portion 31. An end of the connection shaft 32 away from the connection portion 31 is connected to the first rotary encoder 6.

Specifically, the connection portion 31 and the connection shaft 32 may be connected in a T-shape. The connection portion 31 and the connection shaft 32 may be integrally formed or may be separately and removably connected. The connection portion 31 is assembled and connected to the turntable 2, and the two are relatively fixed. The connection shaft 32 protrudes from the connection portion 31 to be assembled and connected to the first rotary encoder 6. Therefore, through the connection portion 31 and the connection shaft 32, the first rotary encoder 6 and the turntable 2 can rotate coaxially, enabling the first rotary encoder 6 to determine whether the turntable 2 has rotated into position. Compared with the mechanical positioning method in the related art, the first embodiment of the present application can achieve full closed-loop feedback of the position and has higher positioning accuracy.

Furthermore, the first rotary encoder 6 includes a first rotary portion 61 coaxially arranged with the connection shaft 32, and a first measurement portion 62 disposed on the outer peripheral side of the first rotary portion 61. The first measurement portion 62 is configured to measure the rotational angle data of the first rotary portion 61 and feed it back to an external controller.

Specifically, the first rotary encoder 6 includes the first rotary portion 61 and the first measurement portion 62. The first rotary portion 61 is fixedly connected to the connection shaft 32 of the rotating connection member 3, and the first measurement portion 62 is disposed on the peripheral side of the first rotary portion 61. The turntable 2 is fixedly connected to the connection portion 31, while the first rotary portion 61 is fixedly connected to the side of the connection shaft 32 away from the turntable 2. That is, the first rotary portion 61 and the turntable 2 are positioned at opposite ends of the rotating connection member 3, respectively. Therefore, when the motor 4 drives the reducer 5 to rotate, the reducer 5 drives the rotating connection member to rotate, and the rotating connection member can drive the first rotary portion 61 and the turntable 2 to rotate synchronously. The first measurement portion 62 is located on the peripheral side of the first rotary portion 61 and is fixed in place. The first measurement portion 62 can measure the rotation angle of the first rotary portion 61, i.e., the rotation angle of the motor 4, and feed the rotation angle data back to the external controller, thereby enabling the positioning of the objective mounting hole 21 of the turntable 2, ensuring that the objective mounting hole 21 can precisely reach the set position. Compared to the mechanical positioning method in the related art, the first embodiment of the present application can achieve full closed-loop feedback of the position and has higher positioning accuracy.

Furthermore, the end of the connection shaft 32 away from the connection portion 31 is provided with an embedding groove, and the first rotary portion 61 is provided with a protruding shaft that protrudes from the first measurement portion 62, with the protruding shaft embedded in the embedding groove.

Specifically, the center of the connection shaft 32 may be provided with the embedding groove, and the center of the first rotary portion 61 may be provided with the protruding shaft. By embedding the protruding shaft into the embedding groove, the first rotary portion 61 and the connection shaft 32 may be assembled and connected, thereby fixing the first rotary portion 61 and the connection shaft 32 relative to each other. Thus, when the connection shaft 32 rotates, the first rotary portion 61 and the connection portion 31 can rotate synchronously, while the connection portion 31 drives the turntable 2 to rotate synchronously, thereby enabling positioning detection of the objective mounting hole 21 via the first rotating encoder 6.

Furthermore, the microscope objective turret further includes a coupling 7, which is disposed between the motor 4 and the reducer 5. The reducer 5 and the motor 4 rotate coaxially via the coupling 7, and the connection shaft 32 is sequentially arranged through the reducer 5, the coupling 7, and the motor 4 to connect with the first rotary encoder 6.

Specifically, the coupling 7 is provided between the reducer 5 and the motor 4, thereby enabling the reducer 5 and the motor 4 to rotate coaxially. The reducer 5, the coupling 7, and the motor 4 are all hollow structures. The connection shaft 32 extends from one end of the connection portion 31 through the reducer 5, the coupling 7, and the motor 4 in sequence, and protrudes from the motor 4 and extends to connect with the first rotary encoder 6, thereby being assembled and connected to the first rotary encoder 6. Thus, through the coupling 7, the motor 4 can drive the reducer 5 to rotate, thereby driving the connection portion 31 and the connection shaft 32, and further driving the turntable 2 and the first rotary encoder 6 to rotate synchronously, thereby achieving precise positioning of the objective mounting hole 21 of the turntable 2. Additionally, by configuring the rotating connection member 3 to pass through the reducer 5, the coupling 7, and the motor 4, such that the two ends of the rotating connection connected to the turntable 2 and first rotary encoder 6, respectively, the internal space utilization of the device is improved, resulting in a more compact structure and reduced dimensions.

Furthermore, the microscope objective turret includes a motor mount 8 for accommodating the motor 4 and is fixedly accommodated within the accommodating space 100. Opposite end of the motor mount 8 along the connection shaft 32 are provided a first clearance hole 801 and a second clearance hole 802, respectively. The coupling 7 is at least partially located within the first clearance hole 801 to connect to the motor 4. The end of the connection shaft 32 close to the first rotary encoder 6 extends through the second clearance hole 802 to be assembled and connected to the first rotary encoder 6.

Specifically, the microscope objective turret further includes the motor mount 8 for accommodating the motor 4 and is fixedly assembled to the base 1, and the motor mount 8 is accommodated within the accommodation space 100. The motor mount 8 is provided with the first clearance hole 801 and the second clearance hole 802 opened at both ends along the connection shaft 32. The coupling 7 is at least partially located within the first clearance hole 801, enabling the coupling 7 to be connected to the motor 4, while the other end of the coupling 7 is connected to the reducer 5 outside the first clearance hole 801. The connection shaft 32 passes through the reducer 5, the coupling 7, and the motor 4 in sequence from the connection portion 31, and the connection shaft 32 protrudes from the second clearance hole 802, enabling the connection shaft 32 to be assembled and connected to the first rotary encoder 6 outside the second clearance hole 802. This configuration allows the rotating connection member 3, the motor mount 8, the motor 4, the reducer 5, and the coupling 7 to be stably accommodated within the accommodating space 100, thereby improving the internal space utilization of the device, making the structure more compact, and reducing its dimensions.

Furthermore, the motor mount 8 includes a base plate 81 fixedly connected to the base 1 and a side wall 82 connected to one side of the base plate 81 and surrounding the outer peripheral side of the motor 4. The base 1 has a groove 12, and the side of the base plate 81 away from the side wall 82 covers the groove 12 to form an assembly space for accommodating the first rotary encoder 6.

Specifically, the motor mount 8 includes a base plate 81 and a side wall 82, where the base plate 81 and the base 1 may be assembled and connected by screw connection, male-female connection, or welding, and the side wall 82 surrounds the outer peripheral side of the motor 4. Additionally, the base 1 is provided with a groove 12, with the opening of the groove 12 facing the motor mount 8. The base plate 81 covers the groove 12, such that an assembly space between the base plate 81 and the groove 12 is formed, and the first rotary encoder 6 can be accommodated within the assembly space. Thus, the relative positions of the base 1, the first rotary encoder 6, the rotating connection member 3, the motor mount 8, the motor 4, the reducer 5, the coupling 7, and the turntable 2 can be determined.

Furthermore, the base plate 81 may be a base plate structure, while the side wall 82 may be a hollow annular column with openings at both ends, one of which is the first clearance hole 801, and the other is covered by the side of the base plate 81 away from the groove 12. The second clearance hole 802 is formed in the base plate 81, allowing the connection shaft 32 of the rotating connection member 3 to protrude from the base plate 81 toward the assembly space to be connected to the first rotary encoder 6.

Furthermore, the outer peripheral side of the base 1 is provided with a first limiting groove 13 with an opening facing the turntable 2, and the outer peripheral side of the turntable 2 is provided with a second limiting groove 22 with an opening facing the base 1. The first limiting groove 13 and the second limiting groove 22 are arranged oppositely and spaced apart to form a limiting space. The microscope objective turret further includes a support member 10 disposed in the limiting space.

Specifically, the support member 10 is a rigid structure. The first limiting groove 13 and the second limiting groove 22 may be configured in a “[” shape with opposing openings, thereby forming a limiting space between the two grooves. The two limiting grooves are spaced apart, such that the limiting space includes the internal space defined by the two limiting grooves and the space between the two limiting grooves. The support member 10 is located within the limiting space. With this configuration, when driving unit 4 drives the turntable 2 to rotate relative to the base 1, the support member 10 does not interfere with the relative rotation of the turntable 2 and the base 1, while also providing support force, enabling the turntable 2 and the base 1 to rotate relative to each other stably under the support of support member 10. Since the support member 10 is a rigid structure, compared to the structural configuration using inner ring bearings and outer ring bearings in the related art, the turntable 2 does not produce a radial deflection angle during rotation, strictly ensuring positional accuracy, enhancing structural rigidity, and improving structural load-bearing capacity.

Furthermore, the microscope objective turret further includes a protrusion 14 fixedly connected to the side of the base 1 away from the turntable 2. The protrusion 14 is provided with an mounting hole 141 communicating with the light-transmitting hole 11, and the protrusion 14 is configured to connect to external devices.

Specifically, the protrusion 14 may be a dovetail groove, which may be configured to match the external device, enabling the entire device assembly to connect with external devices. Different external devices may be matched with different protrusions 14, thereby allowing the microscope objective turret to be compatible with various external devices, enhancing practicality.

Furthermore, in some specific embodiments, the light-transmitting aperture 11 is equipped with a light-transmitting sleeve for preventing stray light. The light-transmitting sleeve can prevent stray light in the optical path. Additionally, an end of the light-transmitting sleeve away from the turntable 2 is provided with the protrusion 14.

Furthermore, the turntable 2 is provided with a plurality of adapter rings corresponding to the objective mounting holes 21. Different adapter rings are configured to match different objective lenses, thereby meeting the requirements for various magnification levels. When replacing an objective lens, the turntable 2 can be rotated to position the objective mounting hole 21 corresponding to the target objective lens at the desired location, aligning it with the light-transmitting aperture 11, after which the required adapter ring and objective lens can be installed.

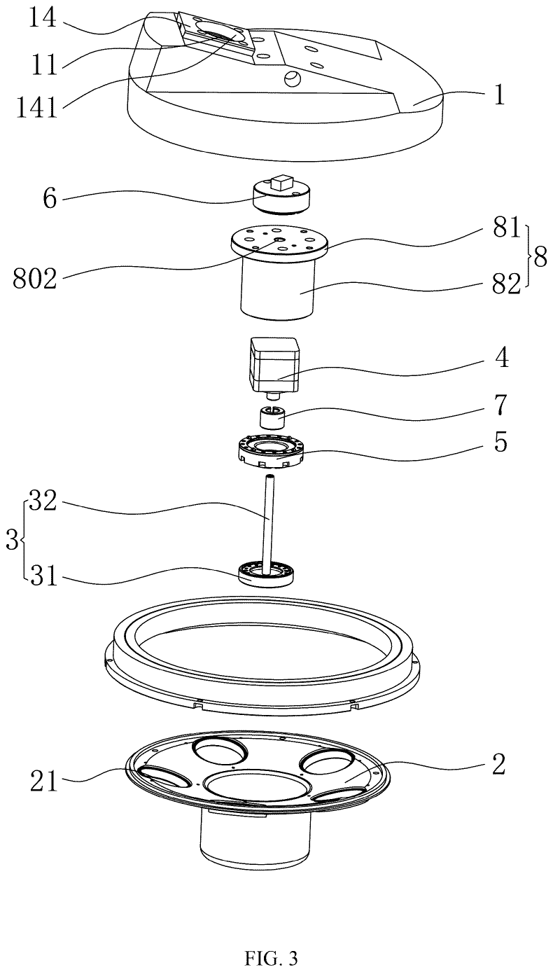

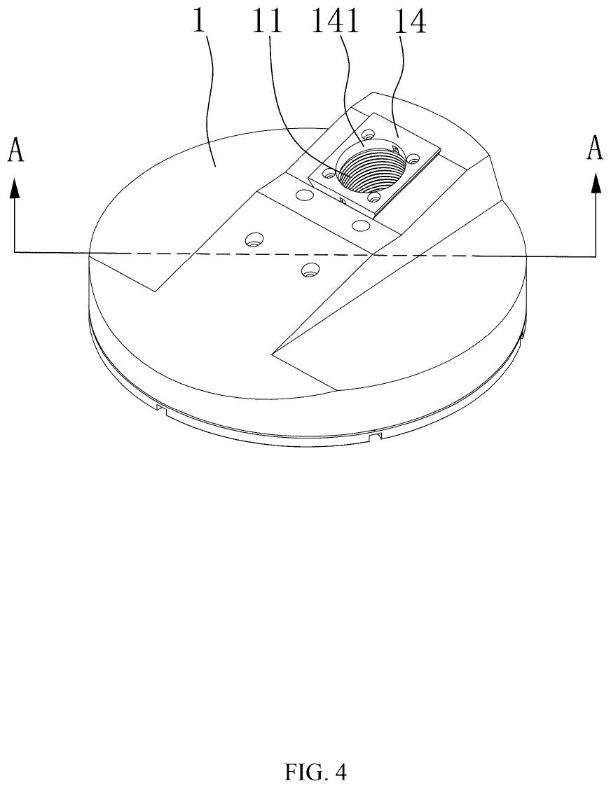

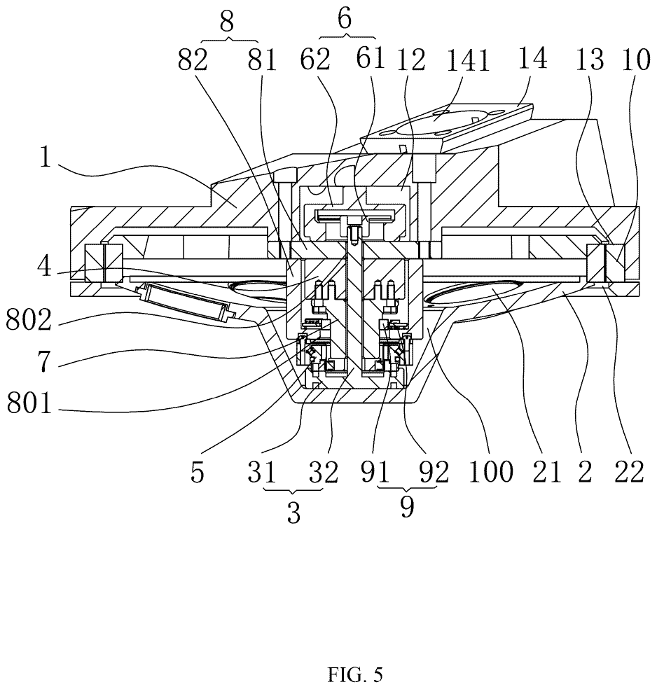

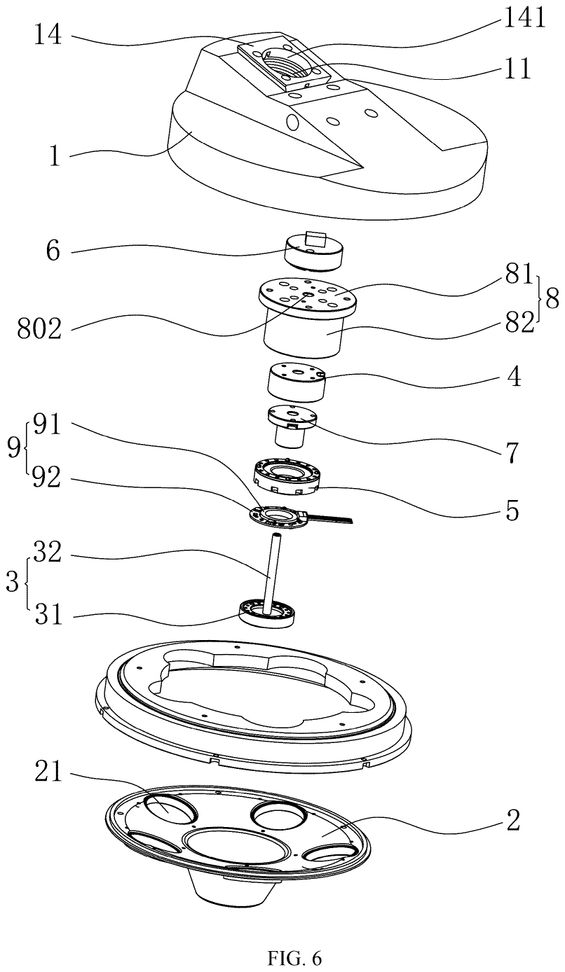

As shown in FIGS. 3 to 6, the second embodiment of the present application provides a microscope objective turret. Similar to the first embodiment, the microscope objective turret of the second embodiment of the present application also includes a base 1 and a turntable 2 that is rotatably connected to the base 1 and forming an accommodating space 100 with the base 1. The base 1 is provided with a light-transmitting aperture 11, the turntable 2 is provided with a plurality of objective mounting holes 21, and the light-transmitting aperture 11 is aligned with any one of the objective mounting holes 21. The microscope objective turret further includes a rotating connection member 3 fixedly connected to the turntable 2 and accommodated within the accommodating space 100, a motor 4 coaxially arranged with the rotating connection member 3, a reducer 5 coaxially and fixedly connected to the motor 4, and a first rotary encoder 6 coaxially arranged with the rotating connection member 3. The motor 4 is configured to drive the reducer 5 to rotate, and the reducer 5 drives the rotating connection member 3 to rotate, thereby driving the first rotary encoder 6 and the turntable 2 to rotate. The first rotary encoder 6 is configured to measure the rotation angle data of motor 4 and feed it back to the external controller.

Thus, the microscope objective turret of the second embodiment of the present application can also determine whether the turntable 2 has rotated into position based on the first rotary encoder 6. Compared with the mechanical positioning method in the related art, the second embodiment of the present application can achieve full closed-loop feedback of the position and has higher positioning accuracy. Additionally, in the second embodiment of the present application, by incorporating the reducer 5, the motor 4 with a smaller power can achieve greater torque, thereby enhancing load-bearing capacity. Further details are omitted here.

Furthermore, the specific structures of the rotating connection member 3, the reducer 5, and the first rotary encoder 6 in the microscope objective turret of the second embodiment of the present application may be the same as those in the first embodiment, thereby achieving the same effect as the first embodiment. Further details are omitted here.

Furthermore, the type of motor 4 in the first embodiment and the type of motor 4 in the second embodiment may be the same or different. For example, in some embodiments, the motor 4 in the first embodiment may be a stepper motor, while the motor 4 in the second embodiment may be a DC motor. In other embodiments, both the motor 4 in the first embodiment and the motor 4 in the second embodiment may be stepper motors, or both may be DC motors.

Furthermore, the microscope objective turret of the second embodiment may also include a coupling 7. The specific structure and shape of the coupling 7 may be adapted to the motor 4 adjustment, and further details are omitted here.

Additionally, the base 1 and turntable 2 of the second embodiment may also form an accommodating space 100. The shape of the accommodating space 100 in the second embodiment may be the same as or different from that of the accommodating space 100 in the first embodiment, depending on the shape of the turntable 2. For example, in some embodiments, the side of the turntable 2 in the first embodiment away from the base 1 is provided with a protruding structure, and the protruding structure is cylindrical. The side of the turntable 2 in the second embodiment away from the base 1 is provided with a protruding structure, and the protruding structure is conical. In some embodiments, the turntables in the first embodiment and the second embodiment may both be tower-shaped.

Furthermore, the microscope objective turret of the second embodiment may also include a support member 10. The base 1 and the turntable 2 may also strictly ensure positional accuracy through the first limiting groove 13, the second limiting groove 22, and the support member 10, thereby enhancing structural rigidity and improving structural load-bearing capacity. Further details are omitted here.

Furthermore, the microscope objective turret of the second embodiment of the present application may also include a motor mount 8, and the specific structure of the motor mount 8 may be the same as that of the motor mount 8 in the first embodiment in terms of structure and effect, and further details are omitted here.

Furthermore, the microscope objective turret of the second embodiment may also include a protrusion 14 on the base 1, a light-transmitting sleeve on the light-transmitting hole 11, and an adapter ring on the objective mounting hole 21, with the same structure and effects as described above, and further details are omitted here.

Furthermore, different from the first embodiment, the microscope objective turret of the second embodiment further includes a second rotary encoder 9 disposed between the motor mount 8 and the coupling 7. The second rotary encoder 9 is configured to measure the rotational angle data of the motor 4 and feed it back to an external controller.

Specifically, the microscope objective turret of the second embodiment also includes a second rotary encoder 9 close to the motor 4. While the motor 4 drives the reducer 5 to rotate, it can also drive the second rotary encoder 9 to rotate. Thus, the rotation angle data of the motor 4 can be detected by the second rotary encoder 9 and fed back to an external controller. The controller can determine whether the target position has been reached based on the difference between the actual data and the set data. If not, the motor 4 continues to drive the rotation until the objective mounting hole 21 on the turntable 2, which serves as the target object, reaches the set target position, thereby achieving positioning of the objective mounting hole 21.

Additionally, the coupling 7 is at least partially located within the first clearance hole 801 of the motor mount 8. By positioning the second rotary encoder 9 between the motor mount 8 and the coupling 7, the second rotary encoder 9 is also located within the first clearance hole 801, and the first rotary encoder 6 is located outside the second clearance hole 802 of the motor mount 8. Thus, the first rotary encoder 6 and the second rotary encoder 9 are respectively located at opposite ends of the connection shaft 32. Therefore, coarse positioning can be achieved using the second rotary encoder 9, while precise positioning can be achieved using the first rotary encoder 6, thereby implementing a dual-encoder positioning method to ensure that the turntable 2 precisely reaches the set position.

Furthermore, the second rotary encoder 9 includes a second rotary portion 91 fixedly sleeved around the outer side of the coupling 7, and a second measurement portion 92 arranged around the outer peripheral side of the second rotary portion 91 and fixedly connected to the motor mount 8. The second measurement portion 92 is used to measure the rotational angle data of the second rotary portion 91 and feed it back to the external controller.

Specifically, the second rotary encoder 9 includes a second rotary portion 91 and a second measurement portion 92. The second rotary portion 91 is fixed relative to the coupling 7, enabling the motor 4 to drive the coupling 7, the second rotary portion 91, and the turntable 2 to rotate synchronously. The second measurement portion 92 is fixedly connected to the motor mount 8, such that the second measurement portion 92 can measure the rotational angle data of the second rotary portion 91, i.e., measure the rotational angle data of the turntable 2, and feed it back to the external controller. The controller can determine whether the target position has been reached based on the difference between the actual data and the set data. If not, the motor 4 continues to drive the rotation until the objective mounting hole 21 on the turntable 2, which serves as the target object, reaches the set target position, thereby achieving positioning of the objective mounting hole 21.

The third embodiment of the present application provides a microscope including a plurality of objective lenses and a microscope objective turret. The plurality of objective lenses are detachably connected to a plurality of objective mounting holes 21.

In the present application, different objectives may be installed on the same objective turret, thereby meeting the requirements for various magnification levels. Additionally, since the objective lens turret is equipped with the first rotary encoder 6, when changing objective lenses, rotating the turntable 2 allows the first rotary encoder 6 to measure position changes, enabling the objective mounting holes 21 on the turntable 2 to rotate to a preset position, thereby achieving high-precision positioning to meet practical requirements.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A microscope objective turret, comprising:
a base having a light-transmitting aperture;
a turntable rotatably connected to the base and forming an accommodating space with the base, wherein the turntable is provided with a plurality of objective mounting holes, and the light-transmitting aperture is aligned with any one of the objective mounting holes;
a rotating connection member fixedly connected to the turntable and accommodated within the accommodating space;
a motor coaxially arranged with the rotating connection member;
a reducer coaxially and fixedly connected to the motor; and
a first rotary encoder coaxially arranged with the rotating connection member, wherein the motor is configured to drive the reducer to rotate, and the reducer drives the rotating connection member to rotate, thereby driving the first rotary encoder and the turntable to rotate; the first rotary encoder is configured to measure rotational angle data of the motor and feed it back to an external controller.

2. The microscope objective turret of claim 1, wherein the rotating connection member comprises a connection portion fixedly assembled to the turntable, and a connection shaft fixedly connected to the connection portion, wherein an end of the connection shaft away from the connection portion is connected to the first rotary encoder.

3. The microscope objective turret of claim 2, wherein the first rotary encoder is provided with a first rotary portion coaxially arranged with the connection shaft and a first measurement portion arranged on an outer peripheral side of the first rotary portion; the first measurement portion is configured to measure rotational angle data of the first rotary portion and feed it back to the external controller.

4. The microscope objective turret of claim 2, further comprising a coupling, which is disposed between the motor and the reducer, wherein the reducer and the motor rotate coaxially via the coupling, and the connection shaft is sequentially arranged through the reducer, the coupling, and the motor from the connection portion to connect with the first rotary encoder.

5. The microscope objective turret of claim 4, further comprising a motor mount for accommodating the motor and fixedly within the accommodation space, wherein opposite end of the motor mount along the connection shaft are provided with a first clearance hole and a second clearance hole, respectively; the coupling is at least partially located within the first clearance hole to connect to the motor, and an end of the connection shaft close to the first rotary encoder extends through the second clearance holes to be assembled and connected to the first rotary encoder.

6. The microscope objective turret of claim 5, wherein the motor mount comprises a base plate fixedly connected to the base and a side wall connected to a side of the base and surrounding an outer peripheral side of the motor; the base is provided with a groove, and a side of the base plate away from the side wall covers the groove to form an assembly space for accommodating the first rotary encoder.

7. The microscope objective turret of claim 5, further comprising a second rotary encoder disposed between the motor support and the coupling, wherein the second rotary encoder is configured to measure the rotational angle data of the motor and feed it back to the external controller.

8. The microscope objective turret of claim 7, wherein the second rotary encoder comprises a second rotary portion fixedly sleeved around an outer side of the coupling, and a second measurement portion arranged around an outer peripheral side of the second rotary portion and fixedly connected to the motor mount, wherein the second measurement portion is configured to measure rotational angle data of the second rotary portion and feed it back to the external controller.

9. The microscope objective turret of claim 1, wherein an outer peripheral side of the base is provided with a first limiting groove with an opening facing the turntable, and an outer peripheral side of the turntable is provided with a second limiting groove with an opening facing the base; the first limiting groove and the second limiting groove are arranged oppositely and spaced apart to form a limiting space, and the microscope objective turret further comprises a support member disposed within the limiting space.

10. A microscope, comprising a plurality of objective lenses and the microscope objective turret of claim 1, wherein the plurality of objective lenses are removably connected to the plurality of objective mounting holes.
